(19) United States
(12) Patent Application Publication
(10) Pub. No.: US 2023/0223756 A1
(43) Pub. Date: Jul. 13, 2023

(54) Power Supporting Arrangement for a Power Grid Having at Least Three Groups of Phase Arms

(71) Applicant: ABB POWER GRIDS SWITZERLAND AG, Baden (CH)

(72) Inventors: Theodore Soong, Toronto (CA); Lexuan Meng, Västerås (SE); Jan Kheir, Västerås (SE); Tong Wu, Västerås (SE); Jean-Philippe Hasler, Västerås (SE); Gunnar Ingestrom, Västerås (SE); Yuhei Okazaki, Västerås (SE); Kalle Ilves, Stockholm (SE); Alexandre Christe, Bern (CH)

(21) Appl. No.: 17/927,543

(22) PCT Filed: May 25, 2020
(86) PCT No.: PCT/EP2020/064359

§ 371 Date: Nov. 23, 2022

(51) Int. Cl. H02J 3/18; H02M 7/493

(52) U.S. Cl. CPC H02J 3/18; H02M 7/493

(57) ABSTRACT

A power supporting arrangement includes a DC network having a first DC line with a first DC potential, a second DC line with a second DC potential, and an energy storage system that includes a first energy storage unit connected in a branch between the first and the second DC lines. A first group of phase arms is connected in a wye-configuration between the power grid and the first DC line and a second group of phase arms connected in a wye-configuration between the power grid and the second DC line. The first and second groups of phase arms are controllable as a voltage source converter. A third group of phase arms is connected to the power grid in a wye-configuration. The third group of phase arms have a neutral point and being controllable to support the power grid with reactive power.

### CROSS-REFERENCE TO RELATED APPLICATIONS

This application is a national stage application of International Application No. PCT/EP2020/064359, filed on May 25, 2020, which application is hereby incorporated herein by reference.

### TECHNICAL FIELD

The present invention generally relates to the supporting of a power grid. Particular embodiments of the present invention relate to a power supporting arrangement for a power grid.

### BACKGROUND

Due to increased adoption of renewables and decommissioning of traditional generation, grid operators are being confronted by power grid systems with low inertia and low short-circuit levels. Focusing on low inertia, which manifests itself as high rate-of-change-of-frequency (ROCOF), fast frequency and synthetic inertia response services are being proposed in some grid codes to mitigate the issue.

Power electronic interfaced energy storage systems (PE-ESS) are strong candidates for providing these new services. Typical energy storage systems use electrochemical (e.g., batteries), dielectric (e.g., supercapacitors), or kinetic (e.g., machine with or without a flywheel).

To provide fast frequency and synthetic inertia response services, an energy storage medium is required. However, some of these, such as electrochemical and dielectric storage, are costly. This leads to grid operators only requesting a real power rating, which may be less than the apparent power required. There is therefore a need for a power supporting arrangement that is able to increase the apparent power in order to allow additional reactive power to be provided from the power supporting arrangement.

### SUMMARY

The present invention is directed towards a power supporting arrangement for a power grid having at least three groups of phase arms. Embodiments can provide a power supporting arrangement that is capable of providing additional reactive power and has an increased apparent power rating.

In one embodiment, the power supporting arrangement comprises a DC network comprising a first DC line with a first DC potential, a second DC line with a second DC potential and an energy storage system comprising a first energy storage unit connected in a branch between the first and the second DC lines. A first group of phase arms is connected in a wye-configuration between the power grid and the first DC line and a second group of phase arms is connected in a wye-configuration between the power grid and the second DC line. The first and second groups of phase arms are controllable (e.g., jointly controllable) as a voltage source converter for supporting the power grid with active power from the energy storage system. A third group of phase arms is connected to the power grid in a wye-configuration, having a neutral point and being controllable to support the power grid with reactive power.

The neutral point of the third group of phase arm may be separated from the DC network. Alternatively, it may be connected to the DC network. In both cases the neutral point may be connected to ground or floating. If the third group of phase arms is connected to the DC network, the neutral point of this group may be connected to a connection point of the DC network, which connection point may be a grounding connection point.

The energy storage system may also comprise a second energy storage unit. The second energy storage unit may be connected in series with the first energy storage unit. It may more particularly be connected in the branch between the first and second DC line that comprises the first energy storage unit. In this case it is also possible that the neutral point of the third group of phase arms is connected to a junction between the first and second energy storage units.

The power supporting arrangement may additionally comprise a fourth group of phase arms connected in a wye-configuration between the power grid and a connection point of the DC network. In case the third group of phase arms is connected to the DC network, the connection point to which the neutral point of the fourth group of phase arms is connected may be the same as that used by the third group of phase arms.

According to some variations, the first and second groups of phase arms comprise half-bridge cells, while the third group of phase arms comprises full-bridge cells. The first and second groups of phase arms may more particularly be made up of or only comprise half-bridge cells. The third group of phase arms may in turn be made up of or only comprise full-bridge cells. In case there is a fourth group of phase arms, this may also comprise full-bridge cells. It may also be made up of or only comprise full-bridge cells.

The DC network may comprise a third DC line having a third DC potential, which third DC potential may be the same as the second DC potential.

In some variations the neutral point of the third group of phase arms is connected to this third DC line.

The energy storage system may additionally comprise a third energy storage unit. If the second energy storage unit is connected in series with the first energy storage unit in the branch between the first and second DC line, the third group of phase arms may in this case be connected to a first end of the third energy storage unit via the third DC line and the third energy storage unit may have a second end connected to the junction between the first and second energy storage units.

Alternatively, in case the branch between the first and second DC lines only comprises the first energy storage unit, the second energy storage unit may be connected in a further branch that stretches between the second and third DC lines. It is in this case possible that this further branch only comprises the second energy storage unit.

As an alternative to the first and second groups of phase arms comprising half-bridge cells, it is possible that all groups of phase arms comprise full-bridge cells. All groups, including the first and second groups may thus comprise full-bridge cells. They may additionally all only comprise full-bridge cells.

The power supporting arrangement may additionally comprise a control device configured to control the first, second and third group of phase arms. If there is a fourth group of phase arms, the control device may also be configured to control the phase arms of this fourth group.

The control being performed by the control device may be a joint control of the first and second groups of phase arms so that at least one of the groups supplies active power while the other supplies reactive power to the power grid. The control may be a control such that only the first group supplies active power and only the second group supplies reactive power. The control may additionally involve a control of the third group phase arms to support the power grid with reactive power. The control of the third group may be separate from the control of the first and second groups. However, if there is a fourth group of phase arms, the control may be a joint control of the first, second, third and fourth groups of phase arms, where the first and fourth groups of phase arms are controlled to supply active power, while the second and third groups are controlled to supply reactive power. In this case it is possible that only the first and fourth groups supply active power and only the second and third groups supply reactive power.

Alternatively, the first and second groups of phase arms may be jointly controlled so that both supply active and reactive power to the power grid. If there are third and fourth groups of phase arms connected to the DC network, they may also both be controlled to supply both active and reactive power to the power grid. In case the neutral point of the third group of phase arms is connected to a junction between the first and second energy storage units and one of the first and second groups of phase arms is faulty with the other being healthy, the third group of phase arms may be jointly controlled with the healthy group of phase arms to supply active and reactive power to the power grid.

Each phase arm in the first group may be part of an upper branch joining the first DC line with a corresponding AC phase of the power grid and each phase arm in the second group may be part of a lower branch joining the second DC line with a corresponding phase of the power grid. It is additionally possible that each phase arm in the fourth group is part of an upper branch and that each phase arm in the third group is part of a lower branch.

The control may nominally involve the first branch providing a first fraction of the DC network voltage and the second branch providing a second fraction of the DC network voltage, where the sum of the fractions is the total DC network voltage, which may be the difference between the first and the second DC potential. The first fraction may be equal to the second fraction, which may be half the DC network voltage.

The control performed by the control device may then comprise adding, for each phase of the power grid, a DC offset to one of the branches and to subtract the DC offset from the other branch, where the DC offset may be set to the fraction of the DC voltage nominally provided by the branch from which the subtraction is made.

The control may additionally involve injecting a fundamental frequency circulating current component in the upper and lower branch, which circulating current component is set to screen a reactive power component formed in the branch with the added offset and to screen an active power component formed in the branch with the subtracted offset.

The phase angle of the steady-state current through the branch with the added offset may be 0° or 180°, the phase angle of the current through the branch with the subtracted offset may be 90° or −90° and the absolute value of the phase angle of the combined currents of the upper and lower branch may be between 60° and 120°.

The present invention has a number of advantages. It enables the provision of additional reactive power and thereby the rated apparent power of the power supporting arrangement may be higher than the rated active power, which allows a limitation of the energy storage system size to be made.

### BRIEF DESCRIPTION OF THE DRAWINGS

The present invention will in the following be described with reference being made to the accompanying drawings, where

FIG. 1 schematically shows a first version of a first embodiment of a power supporting arrangement being connected to a power grid, where the power supporting arrangement comprises a first, second and third group of phase arms as well as an energy storage system,

FIG. 2 schematically shows a second embodiment of the power supporting arrangement connected to the power grid,

FIG. 3 schematically shows a third embodiment of the power supporting arrangement connected to the power grid,

FIG. 4 schematically shows a fourth embodiment of the power supporting arrangement connected to the power grid,

FIG. 5 schematically shows a fifth embodiment of the power supporting arrangement that resembles the second embodiment, and

FIG. 6 schematically shows a second version of the first embodiment of the power supporting arrangement connected to the power grid, and

FIG. 7 shows a number of steps in a method of controlling upper and lower branches comprising the first and second phase arms of the power supporting arrangement.

### DETAILED DESCRIPTION OF ILLUSTRATIVE EMBODIMENTS

In the following, a detailed description of preferred embodiments of the invention will be given.

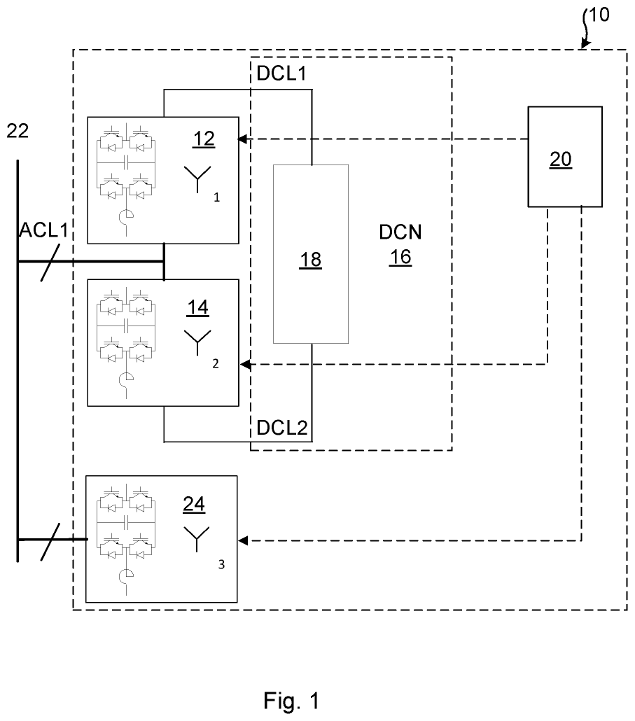

FIG. 1 shows a first variation of a first embodiment of a power supporting arrangement 10 connected to an alternating current (AC) power grid 22. The power supporting arrangement 10 comprises a first and second group of phase arms 12 and 14 and a direct current (DC) network DCN 16 comprising an energy storage system (ESS), where the energy storage system comprises a first energy storage unit 18A. The DC network also comprises a first DC line DCL₁ and a second DC line DCL₂. The first energy storage unit 18 is connected in a branch between the first and the second DC lines DCL₁ and DCL₂.

The phase arms in the first group 12 are wye-connected, where each phase arm is at a first end connected to a corresponding phase of the power grid 22 and at a second end to the first DC line DCL₁, where the first DC line DCL₁ has a first DC potential. The second ends are thereby interconnected and form a neutral point of the wye-connected first group. This neutral point is connected to the first DC line DCL₁. In a similar manner, the phase arms in the second group 14 are also wye-connected, where a first end of each phase arm is connected to a corresponding phase of the power grid 22 and a second end is connected to the second DC line DCL₂, where the second DC line DCL₂ has a second DC potential. The second ends are thereby interconnected and form a neutral point of the wye-connected second group. This neutral point is connected to the second DC line DCL₂. A first group of phase arms connected in a wye-configuration between the power grid and the first DC line.

The second DC potential may be zero or be of equal size as but have an opposite polarity than the first DC potential. The first and second groups of phase arms may additionally together form a voltage source converter (VSC) which due to the phase arm realization may be considered to be a double wye converter having an AC side formed by the first ends of the first and second groups of phase arms 12 and 14 and a DC side formed by the second ends of the first and second groups of phase arms 12 and 14. This is due to the fact that the first and second phase arms may together form an AC waveshape for the power grid 22. For this reason, each phase arm may also comprise cells and in this first variation of the first embodiment, the cells in the first and second groups of phase arms are full-bridge cells. Since cells are used the converter may also be considered to be a double wye modular multilevel converter (MMC).

The first and second groups of phase arms may be jointly controlled as a VSC to support the power grid, which support may involve the energy storage system supporting the grid with active power. The control may additionally comprise a joint control of the first and second groups of phase arms so that at least one of the groups supplies active power while the other supplies reactive power to the power grid. In this first variation of the first embodiment both the first and second groups supply active power to the power grid.

As is known in the art, the AC side may additionally be connected to the power grid 22 via a transformer (not shown).

As was mentioned above the DC network 16 also comprises the first energy storage unit 18, where the first energy storage unit 18 is connected in a branch that stretches between the first and second DC lines DCL₁ and DCL₂. In the first embodiment the branch only comprises the first energy storage unit 18 and therefore a first end of the first energy storage unit 18 is connected to the first DC line DCL₁ and a second end of the first energy storage unit 18 is connected to the second DC line DCL₂. The energy storage system may be an electrochemical, kinetic and/or dielectric energy storage system and the first energy storage unit may therefore comprise flywheels, supercapacitors and/or batteries.

Through the inclusion of cells, the converter made up of the first and second groups of phase arms comprises power electronics. The converter is used for interfacing the energy storage system (ESS) to the grid 22. The converter with energy storage system may because of this additionally be referred to as a double-wye power electronic interfaced energy storage system (PE-ESS).

The power supporting arrangement 10 also comprises a third group of wye-connected phase arms 24 that are typically also made up of full-bridge cells. A first end of each phase arm is therefore connected to a corresponding phase of the power grid 22 while the second ends are interconnected for forming a neutral point—This neutral point may be connected to ground. As an alternative it may be floating. The neutral point is in this case also separated from the DC network. The third group of phase arms 24 may form a first auxiliary voltage source converter that may also be an MMC. This converter may also be termed a parallel converter because it is in essence connected to the grid in parallel with the PE-ESS. The auxiliary converter may also be considered to be a static VAR compensator (STATCOM).

The power supporting arrangement 10 may additionally comprise a control device 20 configured to control the converters, which control may be the control of the first and second groups of phase arms 12 and 14 forming the double wye VSC to support the power grid 22 with active and/or reactive power and the control of the third group of phase arms 24 forming the first auxiliary converter to support the power grid 22 with reactive power.

Requirements do not necessitate that real and apparent power ratings are comparable of the power supporting arrangement. It may therefore be cost effective to add a parallel Wye converter to the double-wye PE-ESS as shown in FIG. 1. It is thereby possible to increase the reactive power provision capability of the power supporting arrangement without increasing the active power provision capability. Thereby the power supporting arrangement may have a higher apparent power rating than active power rating. The raised apparent power rating is also achieved without having to increase the capacity of the energy storage system.

However, the auxiliary converter has no real power capabilities, and typically needs to be controlled separately.

Controllability of the power supporting arrangement may therefore be difficult to implement, especially with regard to stability. For example, it may be that the double-wye PE-ESS is dictated by a swing equation while the auxiliary converter may need to synchronize with a PLL (phase lock loop).

In order to improve on the situation as well as enhance the use of the third group of phase arms used to form the auxiliary converter, aspects of the invention are directed towards connecting the third group of phase arms to the DC network 16. The neutral point of the third group of phase arms 24 may thus be connected to the DC network 16. The third group of phase arms may thereby be integrated into the PE-ESS to create a three-wye PE-ESS. A few different ways in which this may be done will be shown in the following.

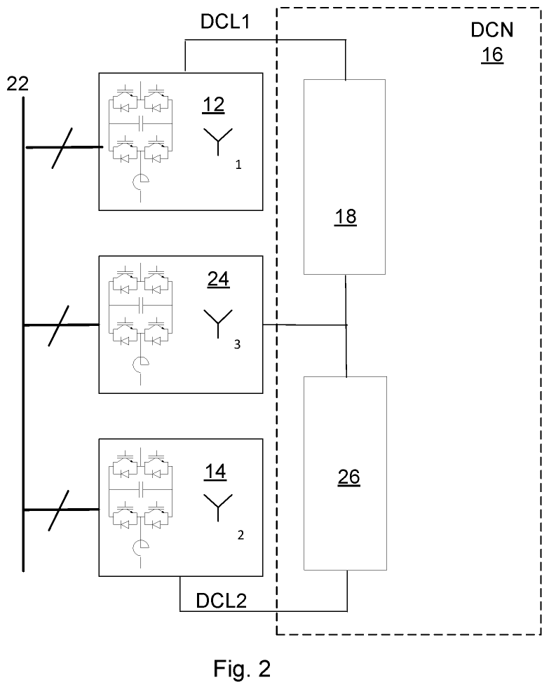

FIG. 2 schematically shows a second embodiment of the power supporting arrangement 10, where this has been done. Here the energy storage system also comprises a second energy storage unit 26, which in this embodiment is also connected in the branch between the first and second DC line DCL₁ and DCL₂ that comprises the first energy storage unit 18. The second energy storage unit 26 is in this case also connected in series with the first energy storage unit 18 in the branch. The first energy storage unit 18 more particularly has a first end connected to the first DC line DCL₁ and a second end connected to a first end of the second energy storage unit 26, where a second end of the second energy storage unit 26 is connected to the second DC line DCL₂. The first and second energy storage units 18 and 26 are thereby connected in series between the first and the second DC lines DCL₁ and DCL₂. The neutral point of the third group of phase arms 24 is in this case connected to the DC network. It is more particularly connected to a connection point of the DC network, which in this case is formed by a junction between the two energy storage units 18 and 26, which junction may in some variations be at ground potential, thereby making the connection point into a grounding connection point. Alternatively, the junction may be floating.

The control may also here comprise controlling the first and second phase arms as a VSC, which may be a joint control of the first and second groups of phase arms so that at least one of the groups supplies active power while the other supplies reactive power to the power grid. In this embodiment both the first and second groups supply active power to the power grid. The third group of phase arms 24 may in this case not contribute to any real power output. However, it may be used as an auxiliary VSC for reactive power support. The third group of phase arms 24 also has the advantage of providing redundancy if one of the energy storage units must be disconnected. If for instance the first energy storage unit 18 becomes faulty, the second and third groups of phase arms 14 and 24 can be controlled as a VSC to make the second energy storage unit 26 support the power grid 22, while the first and third groups of phase arms 12 and 24 can be controlled as a VSC to make the first energy storage unit 18 support the power grid 22 in case the second energy storage unit 26 cannot be used. It can thus be seen that if one of the first and second groups of phase arms is faulty with the other being healthy, the third group of phase arms may be jointly controlled with the healthy group of phase arms to supply active and reactive power to the power grid.

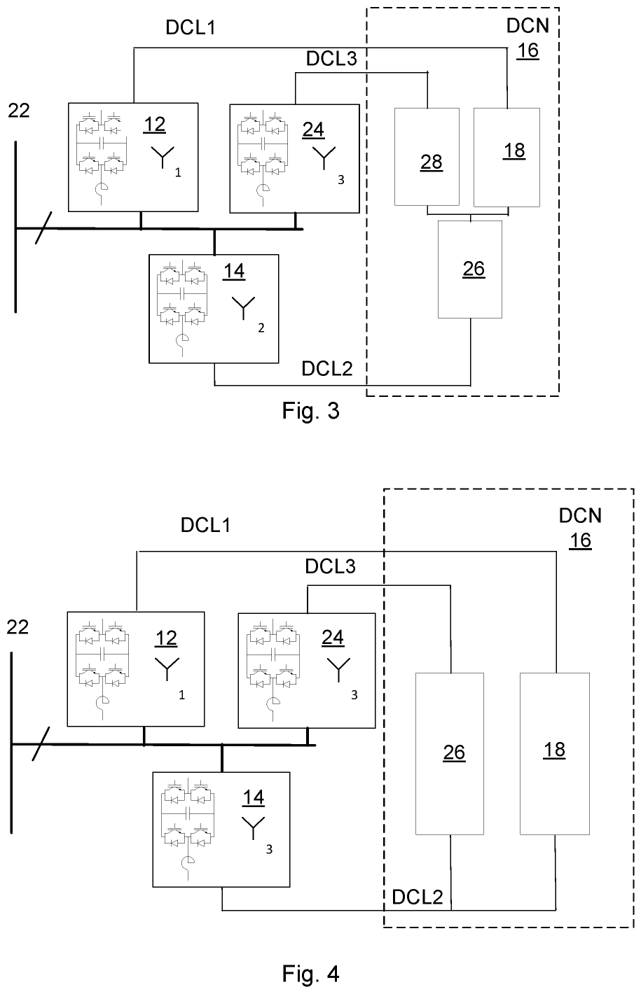

FIG. 3 shows a third embodiment where the third group of phase arms 24 is a part of the PE ESS that also comprises the second energy storage unit 26 connected in series with the first energy storage unit 18 in the branch between the first and second DC lines DCL₁ and DCL₂. Therefore, in this case the first energy storage unit 18 again has the first end connected to the first DC line DCL₁ and the second end connected to a first end of the second energy storage unit 26, where the second end of the second energy storage unit 26 is connected to the second DC line DCL₂. The energy storage system also comprises a third energy storage unit 28 having a first end connected to a third DC line DCL₃ of the DC network 16 and a second end connected to the junction between the first and second energy storage units 18 and 26. The neutral point of the third group of phase arms is thus connected to a first end of the third energy storage unit 28 via the third DC line DCL₃ and the second end of the third energy storage unit 28 is connected to the junction between the first and second energy storage units 18 and 26. Furthermore, in this case the neutral point of the third group of phase arms 24 is connected to the third DC line DCL₃. The third DC line DCL₃ may in this case have a third potential that is the same as the first potential. Through this embodiment the first and third energy storage units 18 and 28 can be operated in parallel together with the second energy storage unit 26 for supporting power grid 22 with both active and reactive power. Redundancy is also possible.

FIG. 4 shows a fourth embodiment comprising the second energy storage unit 26 and the third group of phase arms 24 as a part of the PE ESS. In this case, the neutral point of the third group of phase arms 24 is again connected to the third DC line DCL₃. The second end of the second energy storage unit is again connected to the second DC line DCL₂. However, in this case the first end of the second energy storage unit 26 is connected to the third DC line DCL₃. Thereby, the DC network 16 comprises two parallel DC subsystems that can be used for supporting the power grid 22. The branch between the first and second DC lines DCL₁ and DCL₂ thus only comprises the first energy storage unit 18, while the second energy storage unit 26 is connected in a further branch that stretches between the second and third DC line DCL₂ and DCL₃, where this further branch only comprises the second energy storage unit 26.

For the configurations shown in FIG. 3 and FIG. 4, all three groups of phase arms can produce real power. These configurations have increased controllability because the three wye-connected phase arms can be controlled as a PE-ESS and its response would be dictated by the swing equation. Parallel operation is possible using droop or relative inertia constants. In addition, there is a possibility of redundancy in case an ES unit must be disconnected.

In the embodiments described so far all groups of phase arms comprise full-bridge cells. All groups, including the first second and third groups may thus comprise full-bridge cells. They may additionally all only comprise full-bridge cells. Moreover, the first and second groups of phase arms are jointly controlled as a VSC and both supply active and reactive power to the power grid. In the third and fourth embodiments, where the third group of phase arms are connected to the DC network, this group may also be controlled, together with the second group of phase arms, to supply both active and reactive power to the power grid.

The main advantage of the various aspects described herein is that they can be used in system sizing where reactive and real power are not equal and especially if the reactive power rating is higher than the active power rating.

As can be seen above in FIG. 1, it is possible to connect an auxiliary power converter in parallel with a PE-ESS if the reactive power requirements are high. This may also be cost-effective since additional energy storage elements, such as additional batteries and additional supercapacitors, may be avoided.

Instead of putting the auxiliary power converter in parallel, it can be integrated into the PE-ESS. This results in several different system configurations as shown in FIGS. 2, 3 and 4. These different configurations increase redundancy of energy storage systems and coordinated control of the entire system may lead to system optimization and other benefits.

It should be realized that the embodiments given above are mere examples and that variations can be made. It is for instance possible to connect more converters in parallel with the PE-ESS or include more groups of phase arms as a part of the PE-ESS. It is for instance possible to add one or more further groups of phase arms to the structures in FIGS. 3 and 4, where each such further group has a neutral point connected to a corresponding further DC line connected to a first end of a corresponding further energy storage unit, where the second end of each such further energy storage unit is either connected to the junction between the first and the second energy storage units (third embodiment) or to the second DC line (fourth embodiment).

In the versions above all groups of phase arms were made up of full-bridge cells. It should be realized that it is possible to realize the power supporting arrangement with a mixture of half-bridge and full bridge cells.

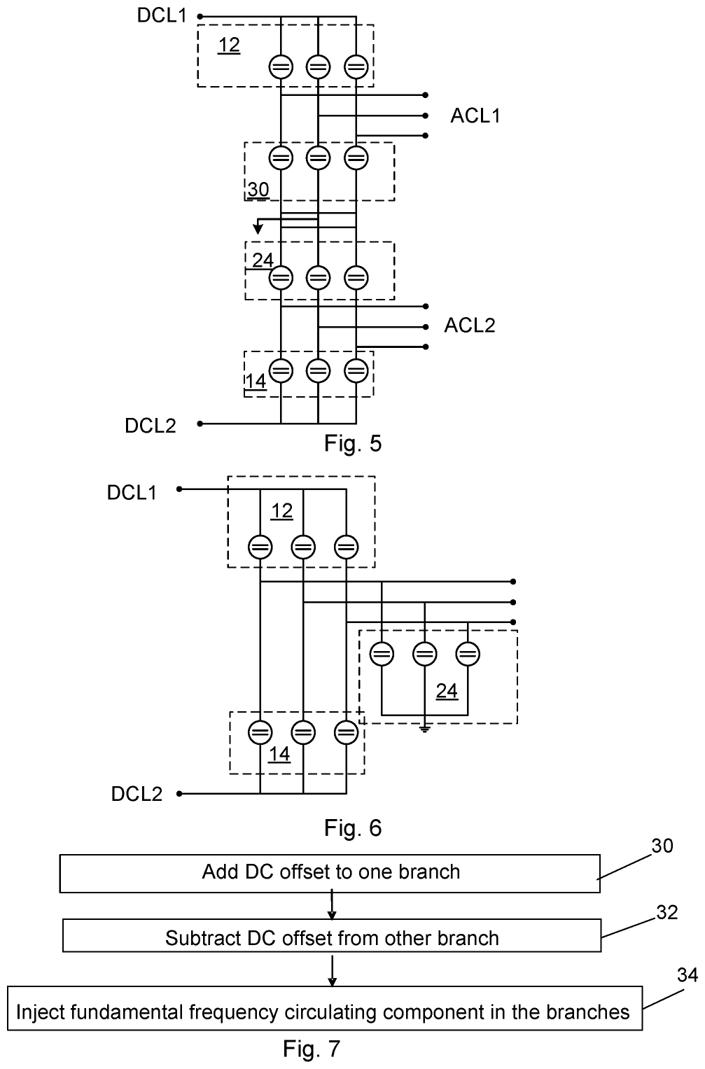

One version of this is shown in FIG. 5, which shows a fifth embodiment that is a variation of the second embodiment. There is here the first group of phase arms 12 with its neutral point connected to the first DC line DCL₁ and the second group of phase arms 14 with its neutral point connected to the second DC line DCL₂, where each phase arm of the first group 12 is at one end connected to a corresponding AC phase via a first AC line ACL₁ and the other ends are interconnected and connected to the first DC line DCL₁. Each phase arm of the second group 14 is at one end connected to a corresponding AC phase via a second AC line ACL₂ and the other ends are interconnected and connected to the second DC line DCL₂.

There is in this case also the third group of phase arms 24 having their first ends connected to the AC phases of the power grid, which is also done via the second AC line ACL₂, with the second ends are interconnected and connected to ground. As can be seen in the figure there is also a fourth group of wye connected phase arms 30, in which group each phase arm comprises a first end connected to a corresponding AC phase of the power grid via the first AC link ACL₁ and the other ends are interconnected and connected to ground. As can be seen the phase arms are shown as voltage sources. It can also be seen that the connection point of the DC network to which the neutral point of the fourth group of phase arms 30 is connected is the same as that used by the third group of phase arms 24.

In this case the first, second, third and fourth groups of phase arms 12, 14, 24 and 30 are jointly controlled as a voltage source converter for supporting the power grid. The first and fourth groups of phase arms 12 and 3o may be operated together to form an AC waveshape on the first AC link ACL₁ and the second and third groups of phase arms 14 and 24 may be operated together to form an AC waveshape on the second AC link ACL₂. Phase arms of the first and fourth groups 12 and 30 that are connected to the same phase of the first AC link ACL₁ in this case form an upper or positive branch, indicated with p, while phase arms of the second and third groups 14 and 24 that are connected to the same phase of the second AC link ACL₂ in this case form a lower or negative branch indicated with n. Each phase arm in the first group is therefore a part of an upper branch joining the first DC line with a corresponding AC phase of the power grid and each phase arm in the second group is a part of a lower branch joining the second DC line with a corresponding phase of the power grid. It can additionally be seen that each phase arm in the fourth group is part of an upper branch and that each phase arm in the third group is part of a lower branch.

In this embodiment, the first and second groups of phase arms 12 and 14 comprise or consist of half-bridge cells, while the third and fourth groups of phase arms 24 and 30 comprise or consist of full-bridge cells. It is additionally possible that the third and fourth groups of phase arms 24 and 30 are considered as a common resource for the two MMCs. The cells of the third group of phase arms 24 may assist in the forming of the waveshape on the second AC link ACL₂ and the cells of the fourth group of phase arms 30 may assist in the forming the waveshape on the first AC link ACL₁.

It should be realized that also here a first and optionally also a second energy storage unit may be connected in series between the two DC lines DCL₁ and DCL₂ and that the neutral points of the third and fourth groups of phase arms 24 and 30 may be connected to the junction between these energy storage units.

FIG. 6 shows a second variation of the first embodiment, where the first and second groups of phase arms 12 and 14 are connected between the phases of the power grid and a corresponding DC line in the same way as in FIGS. 1 and 5. The first and second groups of phase arms 12 and 14 are also connected to the power grid phases via the same first AC line ACL₁. Thereby phase arms of the first group of phase arms form upper or positive branches and phase arms of the second group of phase arms form lower or negative branches.

In this case the first and second groups of phase arms 12 and 14 may form an MMC together operated to form an AC waveshape on the first AC link ACL₁. The third group of phase arms 24 is again acting as a separate VSC and is connected to the phases of the power grid, which is done via a separate connection, i.e. a connection that is separate from the first AC line ACL₁ and with the neutral point being grounded. The difference here from the first variation of the first embodiment is that the cells of the first and second groups of phase arms 12 and 14 are again half-bridge cells and that the cells of the third group of phase arms 24 are full bridge cells just as in the fifth embodiment.

The first and second groups of phase arms of the embodiment shown in FIGS. 5 and 6 thus comprise half-bridge cells, while the third group of phase arms comprises full-bridge cells. The first and second groups of phase arms are more particularly made up of or only comprise half-bridge cells, while the third group of phase arms may in turn be made up of or only comprise full-bridge cells. When there is a fourth group of phase arms, this also comprises full-bridge cells and may more particularly be made up of or only comprise full-bridge cells.

The power supporting arrangement may additionally comprise a control device.

The control of the power supporting arrangement is performed by the control device 20, which is thus configured to control the first, second and third group of phase arms. When there is a fourth group of phase arms, the control device also controls the phase arms of this fourth group.

A mixed-cells MMC with low energy requirement and bipolar DC network compatibility is thus proposed in FIGS. 5 and 6. Compared to the configuration in FIG. 5, the structure in FIG. 6 combines the FB cells into a unique Y-STATCOM. The ground connection maybe required for asymmetric monopole operation in case of loss of one pole.

The mixed-cell realizations of the power supporting arrangement could additionally have a modified operation. The control in this case comprises a joint control of the first and second groups of phase arms so that one of the groups supplies active power while the other supplies reactive power to the power grid. The control being performed by the control device may be a joint control of the first and second groups of phase arms so that at least one of the groups supplies active power while the other supplies reactive power to the power grid. The control may be a control such that only the first group supplies active power and only the second group supplies reactive power. The control may additionally involve a control of the third group phase arms to support the power grid with reactive power. The control of the third group may be separate from the control of the first and second groups. However, if there is a fourth group of phase arms, the control may be a joint control of the first, second, third and fourth groups of phase arms, where the first and fourth groups of phase arms are controlled to supply active power, while the second and third groups are controlled to supply reactive power. In this case it is possible that only the first and fourth groups supply active power and only the second and third groups supply reactive power.

The control features a reduced energy requirement compared to a conventional double-star MMC operated as an enhanced STATCOM. A stored energy requirement reduction is beneficial for the cell protection part. This is of particular importance owing to the ongoing activities around industrial Insulated Gate Bipolar Transistor (IGBT) module-based MMC cell for low-power STATCOM and Medium Voltage Direct Current (MVDC), where the stored energy has a direct impact on the cell bypass dimensioning.

The control may nominally involve the first branch providing a first fraction of the DC network voltage and the second branch providing a second fraction of the DC network voltage, where the sum of the fractions is the total DC network voltage, which may be the difference between the first and the second DC potential. The first fraction may be equal to the second fraction, which may be half the DC network voltage.

The control may then comprise adding, for each phase of the power grid, a DC offset to one of the branches and to subtract the DC offset from the other branch, where the DC offset may be set to the fraction of the DC voltage nominally provided by the branch from which the subtraction is made. The control may additionally involve injecting a fundamental frequency circulating current component in the upper and lower branch, which circulating current component is set to screen a reactive power component in the branch with the added offset and to screen an active power component formed in the branch with the subtracted offset.

As an example the offset may be added to the upper branch and subtracted from the lower branch. For sake of clarity, the following quantities are defined that are used consistently herein:

f_{g}: grid frequency

S: apparent power

V_{dc}: DC-link voltage

φ: grid current angle

k_{ac}: ratio between the peak AC grid voltage and the half DC voltage

The proposed modified mixed-cells MMC operation, which is performed by the control device for the converter branches can be summarized as this for each phase:

A DC offset of Vdc/2 is added to the upper branch and subtracted from the lower branch, such as only the upper branch is supporting the entire DC voltage

$${e}_{p} = {V}_{d c} - {k}_{a c} \frac{{V}_{d c}}{2} ( cos ( ω t ) - \frac{cos ( 3 ω t )}{6} )$$

$${e}_{n} = {k}_{a c} \frac{{V}_{d c}}{2} ( cos ( ω t ) - \frac{cos ( 3 ω t )}{6} )$$

The reactive power component is screened in the upper branch, while the active power component is screened in the lower branch through the injection of a fundamental frequency circulating current, since the lower branch can't exchange any active power with the DC-link through DC components.

$${i}_{circ} = \frac{2 S}{3 {k}_{a c} {V}_{d c}} ( cos ( ϕ ) cos ( ω t ) + sin ( ϕ ) sin ( ω t ) ) = \frac{2 S}{3 {k}_{a c} {V}_{d c}} cos ( ω t - ϕ )$$

As is shown in the flow chart of FIG. 7, the control device of the power supporting arrangement may thereby control the converter being formed at least by the first and second groups of phase arms and optionally also by the third and fourth groups of phase arms to add a DC offset to one branch, step 30, where the DC offset may be half the DC voltage of the DC network. The control device may also control the converter to subtract the DC offset from the other branch, step 32, and to inject a fundamental frequency circulating current in the upper and lower branch, step 34. In the present example the DC offset is added to the upper branch and subtracted from the lower branch.

It follows that the branch currents become

$${i}_{ap} = \frac{{I}_{d c}}{3} + \frac{4 S}{3 {k}_{a c} {V}_{d c}} cos ( ϕ ) cos ( ω t )$$

$${i}_{an} = \frac{{I}_{d c}}{3} + \frac{4 S}{3 {k}_{a c} {V}_{d c}} sin ( ϕ ) sin ( ω t )$$

A comparison of the proposed double-wye MMC operation with DC offset and power components screening with a conventionally operated double-wye MMC indicates that that there is a sweet spot operation range of ±30° around −90° and ±10° around +90° of the grid angle where the required stored energy is less compared to the conventionally operated MMC.

The control may thus involve controlling the upper and lower branches to inject power at a phase angle in a range of −120-−60 degrees to the angle of the power grid or at a phase angle in a range of 80-100 to the angle of the power grid.

It can be realized that the MMC operation (ϕ≈0), where the DC voltage is equally split between the positive and negative branch leads to the lowest stored energy requirement for high power factors, while a STATCOM operation (ϕ≈90°), where the DC voltage is unequally split between the upper and lower branch leads to the lowest stored energy requirement for low power factors.

For a load angle superior to 60° roughly, the STATCOM like operation, with an asymmetrically split DC voltage contribution for the upper and lower branches leads to reduced energy requirement.

Therefore the phase angle of the steady-state current through the branch with the added offset may be 0° or 180°, the phase angle of the current through the branch with the subtracted offset may be 90° or −90° and the absolute value of the phase angle of the combined currents of the upper and lower branch may be between 60° and 120°.

It can be seen that the power supporting arrangement according to FIGS. 5 and 6 and associated operation has the following characteristics:

1. Bipolar DC network with one converter with HB cells and a grounded Y-STATCOM.

2. Operation of a FACTS device operating with a high Q and small P with DC terminals and a low stored energy requirement through asymmetric sharing of the DC voltage component. Thereby it is possible to have 33% FB cells and 66% HB cells.

Some advantages of the converter arrangements in FIGS. 5 and 6 are:

Single converter bipolar operation, where the converter potentially integrated into one valve hall.

Merging of the FB cells functionality in a bipolar system leading to a reduction of the required stored energy.

Simple modification of the conventional operation of a double-star MMC when the operating range is towards low power factor values. The benefits are savings in semiconductor devices and cell bypass circuit requirements.

The control device may be realized as a processor acting on computer instructions, such as one or more discrete components. However, it may also be implemented in the form of a processor with accompanying program memory comprising computer program code that performs the desired control functionality when being run on the processor. A computer program product carrying this code can be provided as a data carrier such as one or more CD ROM discs or one or more memory sticks carrying the computer program code, which acts as a control unit when being loaded into a processor.

From the foregoing discussion it is evident that the present invention can be varied in a multitude of ways. It shall consequently be realized that the present invention is only to be limited by the following claims.

1-19. (canceled)

20. A power supporting arrangement for connection to a power grid, the power supporting arrangement comprising:
a DC network comprising a first DC line with a first DC potential, a second DC line with a second DC potential, and an energy storage system comprising a first energy storage unit connected in a branch between the first and the second DC lines;
a first group of phase arms connected in a wye-configuration, the first group of phase arms connected to the first DC line and designed to be connected between the power grid and the first DC line;
a second group of phase arms connected in a wye-configuration, the second group of phase arms connected to the second DC line and designed to be connected between the power grid and the second DC line, wherein the first and second groups of phase arms are controllable as a voltage source converter for supporting the power grid with active power from the energy storage system; and
a third group of phase arms connected in a wye-configuration, the third group of phase arms having a neutral point and being controllable to support the power grid with reactive power.

21. The power supporting arrangement according to claim 20, wherein the neutral point of the third group of phase arms is connected to the DC network.

22. The power supporting arrangement according to claim 20, wherein the energy storage system further comprises a second energy storage unit.

23. The power supporting arrangement according to claim 22, wherein the second energy storage unit is connected in series with the first energy storage unit in the branch between the first and second DC line.

24. The power supporting arrangement according to claim 23, wherein the neutral point of the third group of phase arms is connected to a junction between the first and second energy storage units.

25. The power supporting arrangement according to claim 20, further comprising a fourth group of phase arms connected in a wye-configuration to be connected between the power grid and a connection point of the DC network.

26. The power supporting arrangement according to claim 25, wherein the neutral point of the third group of phase arms is connected to the DC network and wherein the connection point is the same as that used by the third group of phase arms.

27. The power supporting arrangement according to claim 20, wherein the neutral point of the third group of phase arms is connected to ground.

28. The power supporting arrangement according to claim 20, wherein the first and second groups of phase arms comprise half-bridge cells, while the third group of phase arms comprises full-bridge cells.

29. The power supporting arrangement according to claim 28, further comprising a fourth group of phase arms connected in a wye-configuration to be connected between the power grid and a connection point of the DC network, wherein the fourth group of phase arms comprises full-bridge cells.

30. The power supporting arrangement according to claim 20, wherein the neutral point of the third group of phase arms is connected to a third DC line having a third DC potential.

31. The power supporting arrangement according to claim 30, further comprising a second energy storage unit connected in a branch between the second and third DC lines.

32. The power supporting arrangement according to claim 20, wherein the first, second and third groups of phase arms each comprise full-bridge cells.

33. The power supporting arrangement according to claim 20, wherein the first and second groups of phase arms are jointly controllable so that both can supply active and reactive power to the power grid.

34. The power supporting arrangement according to claim 33, wherein the energy storage system further comprises a second energy storage unit, wherein the second energy storage unit is connected in series with the first energy storage unit in the branch between the first and second DC line, wherein the neutral point of the third group of phase arms is connected to a junction between the first and second energy storage units, and wherein the power supporting arrangement is configured to that the third group of phase arms is jointly controllable with a healthy group of phase arms to supply active and reactive power to the power grid when one of the first and second groups of phase arms is faulty with the other being the healthy group.

35. The power supporting arrangement according to claim 20, wherein each phase arm in the first group is part of an upper branch joining the first DC line with a corresponding AC phase of the power grid and each phase arm in the second group is part of a lower branch joining the second DC line with a corresponding phase of the power grid, the power supporting arrangement further comprising a control device configured to add, for each phase of the power grid, a DC offset to one of the branches and to subtract the DC offset from the other branch.

36. The power supporting arrangement according to claim 35, wherein the control device is configured to inject a fundamental frequency circulating current component in the upper and lower branch, the circulating current component being set to screen a reactive power component formed in the branch with the added offset and to screen an active power component formed in the branch with the subtracted offset.

37. The power supporting arrangement according to claim 35, wherein a phase angle of a steady-state current through the branch with the added offset is 0° or 180°, a phase angle of a current through the branch with the subtracted offset is 90° or −90° and an absolute value of a phase angle of the combined currents of the upper and lower branch is between 60° and 120°.

38. A power supporting arrangement for connection to a power grid, the power supporting arrangement comprising:
a DC network comprising a first DC line with a first DC potential, a second DC line with a second DC potential, a third DC line having a third DC potential, and an energy storage system comprising a first energy storage unit, a second energy unit and a third energy storage unit, wherein the first energy unit is connected in a branch between the first and the second DC lines, wherein the second energy storage unit is connected in series with the first energy storage unit in the branch between the first and second DC line, and wherein the third energy storage unit is connected to a junction between the first and second energy storage units;
a first group of phase arms connected in a wye-configuration, the first group of phase arms connected to the first DC line and designed to be connected between the power grid and the first DC line;
a second group of phase arms connected in a wye-configuration, the second group of phase arms connected to the second DC line and designed to be connected between the power grid and the second DC line, wherein the first and second groups of phase arms are controllable as a voltage source converter for supporting the power grid with active power from the energy storage system; and
a third group of phase arms connected in a wye-configuration, the third group of phase arms having a neutral point connected to the third DC line and being controllable to support the power grid with reactive power, wherein the third energy storage unit is connected between the junction between the first and second energy storage units and the third group of phase arms.
